(19) United States
(12) Patent Application Publication
(10) Pub. No.: US 2019/0168168 A1
(43) Pub. Date: Jun. 6, 2019

(54) SUPERHYDROPHOBIC MICROFILTRATION MEMBRANE FOR MEMBRANE DISTILLATION, FILTRATION MODULE FOR MEMBRANE DISTILLATION COMPRISING THE SAME, AND METHOD FOR MANUFACTURING THE SAME

(71) Applicant: KOLON INDUSTRIES, INC., Seoul (KR)

(72) Inventors: Ji Yoon LEE, Seoul (KR); Kwang-Jin LEE, Seoul (KR)

(73) Assignee: KOLON INDUSTRIES, INC., Seoul (KR)

(21) Appl. No.: 16/312,625

(22) PCT Filed: Jun. 16, 2017
(86) PCT No.: PCT/KR2017/006296

§ 371 Date: Dec. 21, 2018

(30) Foreign Application Priority Data
Jun. 24, 2016 (KR) 10-2016-0079511

(51) Int. Cl. B01D 67/00; B01D 71/36; B01D 71/34; B01D 71/26; B01D 69/02; B01D 61/14

(52) U.S. Cl. CPC B01D 67/0093; B01D 71/36; B01D 71/34; B01D 71/26; B01D 2323/04; B01D 69/02; B01D 61/147; B01D 2325/38; B01D 2325/028; B01D 67/0027

(57) ABSTRACT

Disclosed are a superhydrophobic microfiltration membrane capable of facilitating higher permeate flux without separation performance deterioration when performing a water treatment based on a membrane distillation method, a filtration module for membrane distillation comprising the same, and a method for manufacturing the same. The superhydrophobic microfiltration membrane of the present invention comprises a porous member having a plurality of fine pores having an average pore size of 1 μm to 100 μm and has a pure water contact angle of 130° or more.

### TECHNICAL FIELD

The present invention relates to a superhydrophobic microfiltration membrane for membrane distillation, a filtration module for membrane distillation comprising the same, and a method for manufacturing the same, and more particularly, to a superhydrophobic microfiltration membrane capable of facilitating higher permeate flux without separation performance deterioration when performing a water treatment based on a membrane distillation method, a filtration module for membrane distillation comprising the same, and a method for manufacturing the same.

### BACKGROUND ART

A problem of water shortage is getting more serious due to the climate change consequent upon global warming, the increased usage of industrial water consequent upon industrialization, the increased usage of water consequent upon population growth, and so on. A method to solve the water shortage problem is to use a technology capable of removing salts out of seawater which occupies about 97% of water existing on earth, i.e., a seawater desalination technology.

The seawater desalination technology is mainly classified into an evaporation method and a reverse osmosis method. Although the seawater desalination technology using the evaporation method has proliferated in and around the Middle East area where the water shortage problem is serious, as the concern about the enormous energy consumption increases, it is losing its appeal as a future seawater desalination technology. For this reason, the seawater desalination technology using the reverse osmosis method is increasingly used.

However, the reverse osmosis method has a lot of drawbacks. For example, it is vulnerable to membrane contamination since a feed water of high pressure is supplied to a reverse osmosis membrane, it is difficult to drive and manage a system since multiple pretreatment processes for inhibiting the contamination of the reverse osmosis membrane are required, and a large amount of energy is consumed since it is operated with a pressure higher than the reverse osmosis pressure.

Accordingly, the studies to replace the reverse osmosis method with a membrane distillation method which requires relatively small amount of energy are carried out.

The membrane distillation method is a method to obtain a pure water out of a feed water using temperature difference between the feed water and a clean water, which are on opposite sides of a membrane. A phase change (liquid=>gas) of the feed water of relatively high temperature occurs at the surface of the membrane. The steam produced by the phase change passes through the fine pores of the membrane, loses heat to the clean water, and condenses into water.

However, since a membrane used for the membrane distillation method is required to allow only a gas to penetrate and not to allow a liquid to penetrate, the diameter of the fine pores formed in the membrane need to be very small (e.g., 0.1 to 0.4 μm), and thus cannot achieve a permeate flux sufficient enough to enable a commercialization, e.g., permeate flux of 20 LMH or higher under the standard condition of temperature difference of 40° C. between feed water and clean water.

If the size of the fine pores of the membrane is increased (e.g., 1 μm or larger) in order to increase the permeate flux, not only the steam but also the liquid containing impurities can pass through the membrane, thereby causing deterioration of separation performance.

### DISCLOSURE

### Technical Problem

Therefore, the present invention is directed to a superhydrophobic microfiltration membrane for membrane distillation capable of preventing these limitations and drawbacks of the related art, a filtration module comprising the same, and a method for manufacturing the same.

An aspect of the present invention is to provide a superhydrophobic microfiltration membrane for membrane distillation capable of facilitating higher permeate flux without separation performance deterioration when performing a water treatment based on a membrane distillation method.

The another aspect of the present invention is to provide a filtration module comprising a superhydrophobic microfiltration membrane capable of facilitating higher permeate flux without separation performance deterioration when performing a water treatment based on a membrane distillation method.

The further another aspect of the present invention is to provide a method for manufacturing a superhydrophobic microfiltration membrane capable of facilitating higher permeate flux without separation performance deterioration when performing a water treatment based on a membrane distillation method.

Additional aspects and features of the present invention will be set forth in part in the description which follows and in part will become apparent to those having ordinary skill in the art upon examination of the following or may be learned from practice of the invention.

### Technical Solution

In accordance with the aspect of the present invention, there is provided a superhydrophobic microfiltration membrane for membrane distillation, wherein the superhydrophobic microfiltration membrane comprises a porous member having a plurality of fine pores having an average pore size of 1 μm to 100 μm and has a pure water contact angle of 130° or more.

The average pore size of the plurality of fine pores may be 10 μm to 100 μm, and a 99% nominal pore size of the plurality of fine pores may be 110 μm or less.

The average pore size of the plurality of fine pores may be 20 μm to 90 μm, and a 99% nominal pore size of the plurality of fine pores may be 95 μm or less.

The average pore size of the plurality of fine pores may be 35 μm to 80 μm, and a 99% nominal pore size of the plurality of fine pores may be 85 μm or less.

The pure water contact angle may be 150° or more.

The porous member may include at least one selected from the group consisting of polytetrafluoroethylene, polyethylene, and polyvinylidene fluoride.

The porous member may be one which has been surface-treated by a plasma sputtering.

The porous member may have a surface modified with at least one selected from the group consisting of —CF₃, —CF₂H, —CF₂—, and —CH₂—CF₃.

The superhydrophobic microfiltration membrane may further comprise a hydrophobic layer on the porous member.

The hydrophobic layer may comprise a mixture of nanoparticles and polymer base material. The nanoparticles may include at least one selected from the group consisting of (i) silica particle, (ii) CaCO₃ particle, and (iii) Boehmite particle, and the polymer base material may include at least one selected from the group consisting of (i) a copolymer of fluoroalkyl and methyl methacryl, (ii) a fluorine-containing polymer, and (iii) Anatase.

In accordance with another aspect of the present invention, there is provided a filtration module for membrane distillation comprising a housing; and a filtration membrane dividing an inner space of the housing into a first flow path constituting a part of a feed water circulation path and a second flow path constituting a part of a permeate circulation path, wherein the filtration membrane is the hydrophobic microfiltration membrane.

In accordance with further another aspect of the present invention, there is provided a method for manufacturing a hydrophobic microfiltration membrane for membrane distillation, the method comprising forming a porous member having a plurality of fine pores having an average pore size of 1 μm to 100 μm and making a surface of the porous member superhydrophobic to such a degree that the superhydrophobic microfiltration membrane has a pure water contact angle of 130° or more.

The average pore size of the plurality of fine pores may be 10 μm to 100 μm, and a 99% nominal pore size of the plurality of fine pores may be 110 μm or less.

The average pore size of the plurality of fine pores may be 20 μm to 90 μm, and a 99% nominal pore size of the plurality of fine pores may be 95 μm or less.

The average pore size of the plurality of fine pores may be 35 μm to 80 μm, and a 99% nominal pore size of the plurality of fine pores may be 85 μm or less.

The pure water contact angle may be 150° or more.

The porous member may be formed of at least one selected from the group consisting of polytetrafluoroethylene, polyethylene, and polyvinylidene fluoride by means of a 3D printer.

The making the surface of the porous member superhydrophobic may comprise performing a surface treatment of the porous member by means of a plasma sputtering.

The making the surface of the porous member superhydrophobic may comprise modifying the surface of the porous member with at least one selected from the group consisting of —CF₃, —CF₂H, —CF₂—, and —CH₂—CF₃.

The making the surface of the porous member superhydrophobic may comprise forming a hydrophobic layer on the porous member. The hydrophobic layer may be formed of a mixture of nanoparticles and polymer base material. The nanoparticles may include at least one selected from the group consisting of (i) silica particle, (ii) CaCO₃ particle, and (iii) Boehmite particle, and the polymer base material may include at least one selected from the group consisting of (i) a copolymer of fluoroalkyl and methyl methacryl, (ii) a fluorine-containing polymer, and (iii) Anatase.

It is to be understood that both the foregoing general description and the following detailed description of the present invention are exemplary and explanatory and are intended to provide further explanation of the invention as claimed.

### Advantageous Effect

According to the present invention, when water treatment is performed based on membrane distillation method, high permeate flux can be guaranteed without deterioration of separation performance. Therefore, the present invention can facilitate commercialization of seawater desalination system, thereby remarkably reducing the energy consumption required for seawater desalination.

### BRIEF DESCRIPTION OF DRAWINGS

The accompanying drawing, which is included to provide a further understanding of the invention and is incorporated in and constitute a part of this application, illustrate an embodiment of the invention and together with the description serves to explain the principle of the invention.

FIG. 1 schematically shows a membrane distillation system according to an embodiment of the present invention.

### MODE FOR INVENTION

Hereinafter, the embodiments of the present invention will be described in detail with reference to the annexed drawing. The embodiments of the present invention are described only for illustrative purposes to provide better understanding of the invention and are not intended to limit the invention thereto.

It will be apparent to those having ordinary skill in the art that various modifications and variations are possible, without departing from the scope and spirit of the invention. Therefore, the present invention encompasses the inventions as defined by the appended claims and the modifications and variations equivalent thereto as well.

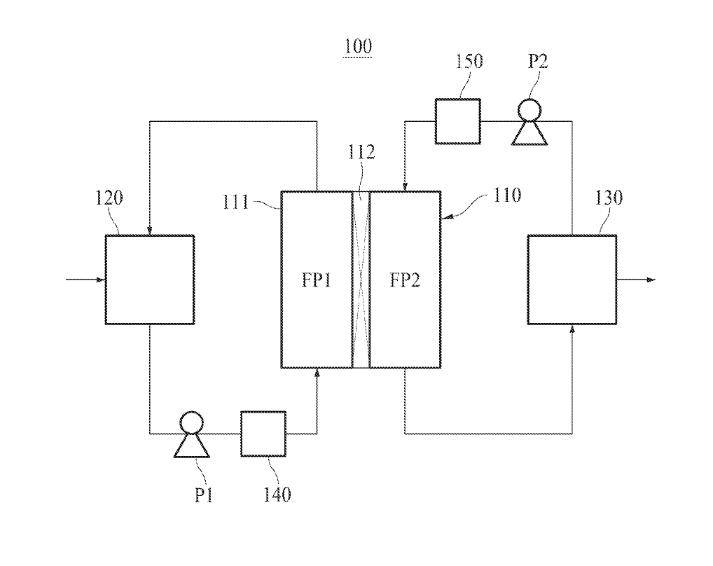

Hereinafter, the membrane distillation system of the present invention will be described in detail. FIG. 1 illustrates a direct contact membrane distillation system.

The membrane distillation system 100 of the present invention comprises a filtration module 110 performing water treatment, a feed water storage tank 120 where a feed water to be treated is stored, and a permeate storage tank 130 where a permeate produced by the filtration module 110 is stored.

As illustrated in FIG. 1, the filtration module 110 according to an embodiment of the present invention comprises a housing 111 and a filtration membrane 112. The filtration membrane 112 is installed in the housing 111 and divides the inner space of the housing 111 into the first flow path FP1 and the second flow path FP2. The first flow path FP1 constitutes a part of the feed water circulation path, and the second flow path FP2 constitutes a part of the permeate circulation path.

Although the filtration module 110 illustrated in FIG. 1 includes a flat sheet membrane as the filtration membrane 112, the filtration membrane 112 of the present invention is not limited to a flat sheet membrane and may be filtration membranes of various shapes, e.g., a hollow fiber membrane. If the filtration membrane is a hollow fiber membrane, the space between the housing and the hollow fiber membrane will serve as the first flow path for the feed water and the lumen of the hollow fiber membrane will serve as the second flow path for the permeate.

The feed water stored in the feed water storage tank 120 is supplied to the filtration module 110 by the first pump P1. If the feed water is seawater, the seawater may be directly supplied from a sea to the filtration module 110 by the first pump P1 without passing through the feed water storage tank 120.

As shown in FIG. 1, for the phase change at the surface of the filtration membrane 112, the feed water may be heated by the heating unit 140 just before supplied to the filtration module 110. If the temperature of the feed water is sufficiently high just like the seawater around the Middle East area, the seawater-heating process by the heating unit 140 may be omitted.

In order to minimized the energy consumption, the heating unit 140 may be a heat exchanger for transferring the waste heat of a power plant to the feed water (i.e., a heat exchanger where the heat is exchanged between the feed water and the steam of high temperature discharged after rotating a turbine of the power plant).

When the feed water supplied to the filtration module 110 passes through the first flow path FP1, a portion thereof transformed into a steam penetrates the filtration membrane 112 and enters the second flow path FP2, and the rest returns back to the feed water storage tank 120.

If the feed water is seawater, after passing through the first flow path FP1, the feed water may be directly discharged to the sea instead of returning back to the feed water storage tank 120.

Although a clean water is stored in the permeate storage tank 130 before the filtration starts, it is gradually replaced with the permeate as the filtration proceeds. Hereinafter, for the convenience of explanation, the clean water will also be called permeate.

The permeate stored in the permeate storage tank 130 is supplied to the filtration module 110 by the second pump P2.

As shown in FIG. 1, for the phase change of the feed water at the surface of the filtration membrane 112, the permeate may be cooled by the cooling unit 150 just before supplied to the filtration module 110.

When the permeate of relatively low temperature supplied to the filtration module 110 passes through the second flow path FP2, a portion of the feed water of relatively high temperature passing through the first flow path FP1, i.e., a portion of the feed water contacting the filtration membrane 112, undergoes phase change due to the temperature difference and changes into a steam. The steam penetrates the filtration membrane 112, moves to the permeate of low temperature, condenses into water, and flows into the permeate storage tank 130 along with the original permeate.

Hereinafter, the filtration membrane 112 of the present invention will be described in more detail.

The filtration membrane 112 of the present invention is a superhydrophobic microfiltration membrane which comprises a porous member having a plurality of fine pores desirably having an average pore size of 1 μm to 100 μm, more desirably 10 μm to 100 μm, further more desirably 20 μm to 90 μm, and still further more desirably 35 μm to 80 μm, and desirably has a pure water contact angle of 130° or more, more desirably 150° or more.

The average pore size of the filtration membrane 112 refers to a statistical mean value of the pore size and can be determined by using a pore size distribution graph obtained by LLDP (Liquid-Liquid Displacement Porosimetry) conducted on a sample taken from the central part of the filtration membrane 112.

The pure water contact angle of the filtration membrane 112 refers to a static contact angle and can be determined by dropping a pure water droplet on the surface of the filtration membrane 112 and measuring the angle between the surfaces of the filtration membrane 112 and the droplet.

Since a membrane distillation method uses the temperature difference between feed water and permeate, which are on opposite sides of a membrane, the temperature difference needs to be maintained above a predetermined level in order to continuously perform the filtration using membrane distillation and guarantee a permeate flux of a certain amount or more. In other words, the filtration membrane for membrane distillation must be able to inhibit or prevent the heat transfer from the feed water of relatively high temperature to the permeate of relatively low temperature.

Therefore, the porous member may include at least one selected from the group consisting of polytetrafluoroethylene (PTFE), polyethylene (PE), and polyvinylidene fluoride (PVDF) in order to make the filtration membrane 112 of the present invention have both high hydrophobicity and low thermal conductivity.

The filtration membrane 112 of the present invention has an average pore size of 1 μm or more, thereby enabling the permeate flux as high as required for commercialization of the membrane distillation method, e.g., permeate flux of 20 LMH or higher under the standard condition of temperature difference of 40° C. between feed water and permeate.

Since the filtration membrane 112 of the present invention has superhydrophobicity so that the pure water contact angle thereof is 130° or more, although the fine pores have relatively large average pore size of 1 μm or more, the wetting of the filtration membrane 112 can be inhibited and only the steam can penetrate the filtration membrane 112. In spite of the superhydrophobicity of the filtration membrane 112 of the present invention, however, if the fine pores have an average pore size more than 100 μm, there would be a risk that the liquid containing the impurities (e.g., salts such as NaCl) will also penetrates the membrane and the separation performance (i.e., salt rejection) will deteriorate.

A surface treatment of the porous member by a plasma sputtering may be performed to increase the surface roughness of the porous member, thereby making the filtration membrane 112 superhydrophobic.

Alternatively, the filtration membrane 112 may be made superhydrophobic by modifying the surface of the porous member with at least one selected from the group consisting of —CF₃, —CF₂H, —CF₂—, and —CH₂—CF₃.

According to another embodiment of the present invention, the surface of the porous member which has been surface-treated by a plasma sputtering may be modified with a fluorinated functional group.

According to further another embodiment of the present invention, the filtration membrane 112 may further comprise a hydrophobic layer on the porous member. The hydrophobic layer may comprise nanoparticles and a polymer base material.

The nanoparticles may include at least one selected from the group consisting of (i) silica particle, (ii) CaCO₃ particle, and (iii) Boehmite particle, and the polymer base material may include at least one selected from the group consisting of (i) a copolymer of fluoroalkyl and methyl methacryl, (ii) a fluorine-containing polymer, and (iii) Anatase.

The wetting of the filtration membrane 112 is caused mainly by the pores of relatively large pore size. The smaller the number of the pores of large pore size is, the higher the anti-wetting property of the filtration membrane 112 is so that satisfactory medium and long term filtration performance can be secured. Thus, according to an embodiment of the present invention, 99% of the pores of the porous member desirably has pore size of 100 μm or less, more desirably 95 μm or less, and further more desirably 85 μm or less. In other words, the pore size corresponding to the pore cumulative number of 99% in the cumulative distribution of pore size in ascending order (hereinafter, “99% nominal pore size”) is desirably 100 μm or less, more desirably 95 μm or less, and further more desirably 85 μm or less. The 99% nominal pore size of the filtration membrane 112 can be obtained by means of LLDP (Liquid-Liquid Displacement Porosimetry).

Hereinafter, a method for manufacturing the filtration membrane 112 of the present invention will be described in detail.

The method of the present invention comprises forming a porous member having a plurality of fine pores having an average pore size of 1 μm to 100 μm, more desirably 10 μm to 100 μm, and making a surface of the porous member superhydrophobic.

As explained above, the porous member may be formed of at least one selected from the group consisting of polytetrafluoroethylene (PTFE), polyethylene (PE), and polyvinylidene fluoride (PVDF) by means of any conventional membrane-manufacturing method.

If the porous member is formed using a conventional membrane-manufacturing method, however, there would be a risk of pore size deviation of such degree that a lot of pores having diameters larger than the average pore size (e.g., diameters larger than 100 μm) might exist. Such big pores are likely to induce the membrane wetting, thereby degrading the separation performance (i.e., salt rejection). Accordingly, in order to make the pore sizes of the plurality of fine pores uniform (i.e., in order to minimize the pore size deviation), the porous member may be formed by means of a 3D printer.

By the step of making the surface of the porous member superhydrophobic, the filtration membrane 112 of the present invention can gain high hydrophobicity of such degree that the pure water contact angle thereof is 130° or more, more desirably 150° or more.

The step of making the surface of the porous member superhydrophobic may comprise performing a surface treatment of the porous member by means of a plasma sputtering. By the surface treatment, the surface roughness of the porous member increases and the filtration membrane 112 can gain the superhydrophobicity so that the pure water contact angle thereof is 130° or more.

The plasma sputtering may be performed using a RF power source in a vacuum. For example, it may be performed using a bias voltage of 700 V in the mixture gas of oxygen and argon (molar ratio=2:1) for 2 hours.

Alternatively, the step of making the surface of the porous member superhydrophobic may comprise modifying the surface of the porous member with a fluorinated functional group. The fluorinated function group may be at least one selected from the group consisting of —CF₃, —CF₂H, —CF₂—, and —CH₂—CF₃. For example, after a plasma etching of the surface of the porous member is performed to roughen the surface, the surface of the porous member may be modified by generating a plasma in a fluorinated gas environment.

According to another embodiment of the present invention, the step of making the surface of the porous member superhydrophobic may comprise forming a hydrophobic layer on the porous member. The hydrophobic layer may be formed of a mixture of nanoparticles and a polymer base material by using a conventional coating method (e.g., spray coating, dip coating, and etc.).

The nanoparticles may include at least one selected from the group consisting of (i) silica particle, (ii) CaCO₃ particle, and (iii) Boehmite particle, and the polymer base material may include at least one selected from the group consisting of (i) a copolymer of fluoroalkyl and methyl methacryl, (ii) a fluorine-containing polymer, and (iii) Anatase.

Hereinafter, the present invention will be described in more detail with reference to the following Examples and Comparative Examples. The following Examples are only given for better understanding of the present invention and should not be construed as limiting the scope of the present invention.

### Example 1

A PTFE porous member having an average pore size of 1 μm and a 99% nominal pore size of 1.2 μm was formed by using a 3D printer. Subsequently, a plasma etching (1.3 kV, 50 mA) was performed on the surface of the porous member in an air atmosphere of 2 Torr for 20 minutes to roughen the surface, and then the surface of the porous member was modified by filling the chamber with CHF₃ gas and generating plasma (2.2 kV, 80 mA) for 5 minutes while maintaining the pressure at 4 Torr, thereby completing a filtration membrane.

### Example 2

A filtration membrane was obtained in the same manner as in Example 1 except that the PTFE porous member had an average pore size of 10 μm and a 99% nominal pore size of 11.8 μm.

### Example 3

A filtration membrane was obtained in the same manner as in Example 1 except that the PTFE porous member had an average pore size of 20 μm and a 99% nominal pore size of 23.3 μm.

### Example 4

A filtration membrane was obtained in the same manner as in Example 1 except that the PTFE porous member had an average pore size of 35 μm and a 99% nominal pore size of 40.5 μm.

### Example 5

A filtration membrane was obtained in the same manner as in Example 1 except that the PTFE porous member had an average pore size of 100 μm and a 99% nominal pore size of 109.5 μm.

### Example 6

A filtration membrane was obtained in the same manner as in Example 1 except that the PTFE porous member was prepared by using a Melt Spinning Cold Stretching (MSCS) method and the PTFE porous member had an average pore size of 25 μm and a 99% nominal pore size of 85.2 μm.

### Comparative Example 1

A commonly used PTFE filtration membrane having an average pore size of 0.1 μm and a 99% nominal pore size of 7.2 μm was prepared.

### Comparative Example 2

A filtration membrane was obtained in the same manner as in Example 1 except that the PTFE porous member had an average pore size of 101.5 μm and a 99% nominal pore size of 118.7 μm.

### Comparative Example 3

A filtration membrane was obtained in the same manner as in Example 1 except that the surface-modifying process was omitted.

Direct contact membrane distillation processes were carried out using the filtration membranes of the aforementioned Examples and Comparative Examples under the following Standard Temperature Difference Condition and Low Temperature Difference Condition, respectively. A feed water containing 50 μS/cm of NaCl was used, the circulation flow rate was 80 mL/min, and the pressure of the circulated water was 0.01 bar. The permeate fluxes and salt rejections were measured respectively and the results thereof are shown in the following Table 1.

Standard Temperature Difference Condition

This is the condition corresponding to a case where the seawater heated with a waste heat generated in volume at a power plant having a cooling tower operated on the coast is used as the feed water. Feed water of 60° C. and permeate of 20° C. were used.

Low Temperature Difference Condition

This is the condition corresponding to a case where the seawater of Middle East area and the underground water are used as the feed water and the permeate, respectively. Feed water of 40° C. and permeate of 20° C. were used.

TABLE 1

| | | | | Standard | | Low | |
|---|---|---|---|---|---|---|---|
| | | | | Temp. Difference | | Temp. Difference | |
| | Porous Member | | | Condition | | Condition | |
| | | 99% | | (60° C./20° C.) | | (40° C./20° C.) | |
| | Average | Nominal | | Permeate | Salt | Permeate | Salt |
| | Pore size | Pore Size | Surface | Flux | Rejection | Flux | Rejection |
| | (μm) | (μm) | Modification | (LMH) | (%) | (LMH) | (%) |
| Ex. 1 | 1 | 1.2 | yes | 84 | >99 | 15 | >99 |
| Ex. 2 | 10 | 11.8 | yes | 550 | >99 | 41 | >99 |
| Ex. 3 | 20 | 23.3 | yes | 825 | >99 | 62 | >99 |
| Ex. 4 | 35 | 40.5 | yes | 960 | >99 | 75 | >99 |
| Ex. 5 | 100 | 109.5 | yes | 1620 | 95 | 96 | 94 |
| Ex. 6 | 25 | 85.2 | yes | 880 | 97 | 68 | 96 |
| Comp. | 0.1 | 7.2 | yes | 15 | >99 | 2 | >99 |
| Ex. 1 | | | | | | | |
| Comp. | 101.5 | 118.7 | yes | 1770 | 82 | 108 | 81 |
| Ex. 2 | | | | | | | |
| Comp. | 1 | 1.2 | no | 95 | 85 | 17 | 84 |
| Ex. 3 | | | | | | | |

As can be seen in Table 1, all the filtration membranes of Examples 1 to 6 showed excellent salt rejections higher than 95% (on the other hand, the filtration membrane of Comparative Example 2 the pore sizes of the porous member of which were larger than 100 μm and the filtration membrane of Comparative Example 3 prepared without surface modification respectively showed salt rejections lower than 85%) and, at the same time, showed permeate fluxes 5.6 times or more higher than and 7.5 times or more higher than those of the filtration membrane of Comparative Example 1, the porous member of which had an average pore size of 0.1 μm, under the standard temperature difference condition and low temperature difference condition, respectively. As explained above, such a high permeate flux enables the commercialization of membrane distillation method.

Particularly, the filtration membranes of Examples 1 to 3 whose porous members have 99% nominal pore sizes smaller than 85 μm showed more excellent salt rejections (i.e., salt rejections more than 99%) than those of Examples 5 and 6 having 99% nominal pore sizes larger than 85 μm.

1. A superhydrophobic microfiltration membrane for membrane distillation, wherein the superhydrophobic microfiltration membrane comprises a porous member having a plurality of fine pores having an average pore size of 1 μm to 100 μm and has a pure water contact angle of 130° or more.

2. The superhydrophobic microfiltration membrane of claim 1, wherein:
the average pore size of the plurality of fine pores is 10 μm to 100 μm; and
a 99% nominal pore size of the plurality of fine pores is 110 μm or less.

3. The superhydrophobic microfiltration membrane of claim 1, wherein:
the average pore size of the plurality of fine pores is 20 μm to 90 μm; and
a 99% nominal pore size of the plurality of fine pores is 95 μm or less.

4. The superhydrophobic microfiltration membrane of claim 1, wherein:
the average pore size of the plurality of fine pores is 35 μm to 80 μm; and
a 99% nominal pore size of the plurality of fine pores is 85 μm or less.

5. The superhydrophobic microfiltration membrane of claim 1, wherein the pure water contact angle is 150° or more.

6. The superhydrophobic microfiltration membrane of claim 1, wherein the porous member includes at least one selected from the group consisting of polytetrafluoroethylene, polyethylene, and polyvinylidene fluoride.

7. The superhydrophobic microfiltration membrane of claim 1, wherein the porous member is surface-treated by a plasma sputtering.

8. The superhydrophobic microfiltration membrane of claim 1, wherein a surface of the porous member is modified with at least one selected from the group consisting of —CF₃, —CF₂H, —CF₂—, and —CH₂—CF₃.

9. The superhydrophobic microfiltration membrane of claim 1, wherein:
the superhydrophobic microfiltration membrane further comprises a hydrophobic layer on the porous member;
the hydrophobic layer comprises a mixture of nanoparticles and polymer base material;
the nanoparticles includes at least one selected from the group consisting of (i) silica particle, (ii) CaCO₃ particle, and (iii) Boehmite particle; and
the polymer base material includes at least one selected from the group consisting of (i) a copolymer of fluoroalkyl and methyl methacryl, (ii) a fluorine-containing polymer, and (iii) Anatase.

10. A filtration module for membrane distillation comprising:
a housing; and
a filtration membrane dividing an inner space of the housing into a first flow path constituting a part of a feed water circulation path and a second flow path constituting a part of a permeate circulation path,
wherein the filtration membrane is the hydrophobic microfiltration membrane of claim 1.

11. A method for manufacturing a hydrophobic microfiltration membrane for membrane distillation, the method comprising:
forming a porous member having a plurality of fine pores having an average pore size of 1 μm to 100 μm; and
making a surface of the porous member superhydrophobic to such a degree that the superhydrophobic microfiltration membrane has a pure water contact angle of 130° or more.

12. The method of claim 11, wherein:
the average pore size of the plurality of fine pores is 10 μm to 100 μm; and
a 99% nominal pore size of the plurality of fine pores is 110 μm or less.

13. The method of claim 11, wherein:
the average pore size of the plurality of fine pores is 20 μm to 90 μm; and
a 99% nominal pore size of the plurality of fine pores is 95 μm or less.

14. The method of claim 11, wherein:
the average pore size of the plurality of fine pores is 35 μm to 80 μm; and
a 99% nominal pore size of the plurality of fine pores is 85 μm or less.

15. The method of claim 11, wherein the pure water contact angle is 150° or more.

16. The method of claim 11, wherein the porous member is formed of at least one selected from the group consisting of polytetrafluoroethylene, polyethylene, and polyvinylidene fluoride by means of a 3D printer.

17. The method of claim 11, wherein the making the surface of the porous member superhydrophobic comprises performing a surface treatment of the porous member by means of a plasma sputtering.

18. The method of claim 11, wherein the making the surface of the porous member superhydrophobic comprises modifying the surface of the porous member with at least one selected from the group consisting of —CF₃, —CF₂H, —CF₂—, and —CH₂—CF₃.

19. The method of claim 11, wherein:
the making the surface of the porous member superhydrophobic comprises forming a hydrophobic layer on the porous member;
the hydrophobic layer is formed of a mixture of nanoparticles and polymer base material;
the nanoparticles includes at least one selected from the group consisting of (i) silica particle, (ii) CaCO₃ particle, and (iii) Boehmite particle; and
the polymer base material includes at least one selected from the group consisting of (i) a copolymer of fluoroalkyl and methyl methacryl, (ii) a fluorine-containing polymer, and (iii) Anatase.
